(19) United States
(12) Patent Application Publication
(10) Pub. No.: US 2026/0358621 A1
(43) Pub. Date: Nov. 12, 2026

(54) Linearly Ganged Displacement Phase Modulator for High Power Laser Processing

(71) Applicant: SILICON LIGHT MACHINES CORPORATION, San Jose, CA (US)

(72) Inventors: James Hunter, Campbell, CA (US); Lars Eng, Los Altos, CA (US); Alexander Payne, Ben Lommond, CA (US); Tianbo Liu, San Jose, CA (US); Yoshimi Hashimoto, Kyoto (JP); Stephen Hamann, Mountain View, CA (US)

(73) Assignee: SILICON LIGHT MACHINES CORPORATION, San Jose, CA (US)

(21) Appl. No.: 19/541,196

(22) Filed: Feb. 16, 2026

Related U.S. Application Data
(60) Provisional application No. 63/760,012, filed on Feb. 18, 2025.

(51) Int. Cl. G02B 26/06; G02B 5/18; H01S 3/00

(52) U.S. Cl. CPC G02B 26/06; G02B 5/1819; G02B 5/1861; H01S 3/0085

(57) ABSTRACT

A displacement phase modulator is provided for high power laser phase modulation processing, manufacturing and communication applications. In one embodiment, the displacement phase modulator includes multiple two dimensional (2D) modulators arranged in columns and rows on a substrate surface to form an array having multiple pixels along a longitudinal axis. Each pixel includes multiple 2D modulators in one or more adjoining columns and has a long axis transverse to the longitudinal axis of the array. The 2D modulators in each pixel are electrically coupled to receive a common input signal and to operate in unison to modulate a phase of light reflected therefrom in response to the input signal. In some embodiments, the 2D modulators include a faceplate with raised elongated reflective elements to form a blaze profile or a phase grating, operable to diffract an incident light into at least two diffraction orders. Other embodiments are also disclosed.

### CROSS-REFERENCE TO RELATED APPLICATIONS

This application claims the benefit of priority under 35 U.S.C. 119(e) to U.S. Provisional Patent Application Ser. No. 63/760,012, filed Feb. 18, 2025.

### TECHNICAL FIELD

The present invention relates generally to spatial light modulators, and more particularly to linearly ganged displacement phase modulators for high power laser phase modulation.

### BACKGROUND

Spatial light modulators or SLMs include an array of one or more devices that can control or modulate phase, intensity or angle of an incident beam of light in a spatial pattern that corresponds to an electrical input to the devices. Spatial light modulators are increasingly being developed for use in various applications, including display systems, optical information processing and data storage, printing, maskless lithography, 3D printing, additive manufacturing, surface modification, optical switching and scanning. SLMs using galvometeric mirrors to steer a single beam of modulated light continues to dominate many applications, however this approach is not easily extended to applications requiring multiple beams and/or higher processing speeds.

More recently, Microelectromechanical systems (MEMS) based SLMs including an array of independently, dynamically adjustable light reflective surfaces modulate the phase, intensity and/or angle of light reflected from the array have proven useful in the aforementioned applications. Currently available SLMs include liquid-crystal-on-silicon (LCOS) modulators, and MEMS-based SLMs such as digital micro-mirror devices (DMDs), and dynamically adjustable diffraction grating, such as the grated light valve (GLV®) and planar light valve (PLV™), commercially available from Silicon Light Machines, Inc., of San Jose, California. In operation electromagnetic radiation or light from a coherent light source, such as a laser, is projected onto an array of mirrors of the MEMS-based SLM, and alignment of the mirrors is altered by electronic signals generating electrostatic forces to displace at least some of the mirrors to modulate the phase, intensity and or angle of light reflected from the array.

While supporting multi beam applications and providing higher modulating speeds than single beam SLMs using galvometeric mirrors these existing MEMS-based SLMs have a number of disadvantages including their inability to handle the high power-density of required in many applications. Laser powers have increased significantly in the recent past with continuous wave lasers of greater than 1 kilowatt (kW) being readily available, and pulsed femtosecond (fs) or picosecond (ps) lasers with energy greater than 1 mJ becoming available soon. The power density or fluence generated by these lasers result in thermal gradients in the reflective surfaces or mirrors of existing MEMS-based SLMs to increase to the point where the mirrors begin to fail. An example failure mode is the “Soret effect” in which atoms of a reflective metal, such as aluminum, covering the mirrors physically migrate ‘downhill’ along the thermal gradient from a hotter to a cooler region reducing the reflection and hence the efficiency of the SLM., and ultimately shortens useful device life.

Accordingly, there is a need for a new MEMS-based light modulator and method of operating the same capable of handling increased illumination (laser) power levels without resulting in extreme thermal gradients that reduce the efficiency and limit the life of the SLM.

### SUMMARY

A displacement phase modulator for high power laser phase modulation processing, manufacturing and communication applications is described. Generally, the displacement phase modulator includes multiple two dimensional (2D) modulators arranged in columns and rows on a substrate surface to form an array having multiple pixels along a longitudinal axis. Each pixel includes multiple 2D modulators in one or more adjoining columns and has a long axis transverse to the longitudinal axis of the array. The 2D modulators in each pixel are electrically coupled to receive a common input signal and to operate in unison to modulate a phase of light reflected therefrom in response to the input signal. The modulators in each pixel can be arranged in one or more adjoining columns perpendicular to the longitudinal axis of the array and parallel to the surface of the substrate. In some embodiments, the long axis of each pixel is coextensive with the short axis of the array, and the pixel extends substantially a full column of the array. Alternatively, the 2D modulators in each pixel can be arranged such that two or more pixels are coaxially along the short axis of the array in one column of the array.

Generally, the displacement phase modulator includes a number of substrate electrodes in a surface of the substrate, and the 2D modulators are microelectromechanical systems (MEMS) based 2D modulators including an electrostatically displaceable actuator suspended above an upper surface on the substrate, the actuator including a tensile layer and including an actuator electrode, and a faceplate supported by and separated from the surface of the substrate by the actuator. The faceplate has a light reflective surface facing away from the actuator; the actuator in each of the 2D modulators is operable to displace the faceplate in response to an input voltage signal applied between the actuator electrode and one of the substrate electrodes. In some embodiments, the faceplates include raised elongated reflective elements to form a blaze profile or a phase grating, operable to diffract an incident light into at least two diffraction orders.

Further features and advantages of embodiments of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to a person skilled in the relevant art(s) based on the teachings contained herein.

### BRIEF DESCRIPTION OF THE DRAWINGS

Embodiments of the invention will now be described, by way of example only, with reference to the accompanying schematic drawings in which corresponding reference symbols indicate corresponding parts. Further, the accompanying drawings, which are incorporated herein and form part of the specification, illustrate embodiments of the present invention, and, together with the description, further serve to explain the principles of the invention and to enable a person skilled in the relevant art(s) to make and use the invention.

FIGS. 1A and 1B are schematic block diagram of a displacement phase modulator (DPM™) including an array of microelectromechanical systems (MEMS) based two-dimensional (2D) modulators;

FIGS. 2A and 2B are schematic diagrams illustrating an embodiment of a MEMS-based 2D modulator for use in the DPM™ of FIGS. 1A and 1B;

FIG. 3 is a schematic block diagram in cross-sectional side view of two 2D modulators in two adjacent pixels illustrating operation in a DPM™;

FIGS. 4A and 4B are schematic block diagrams of, respectively, a perspective view of an underlying actuator layer of a MEMS based two-dimensional (2D) modulator, and a portion of the array of the DPM shown in FIGS. 1A and 1B in which some faceplates have been removed to illustrate an underlying actuator layer and pistons, and electrical ganging of the 2D modulators within a pixel;

FIGS. 5A and 5B are schematic block diagrams of a planar top view of a portion of a linear array in a DPM™ illustrating alternative pixel configurations;

FIGS. 6A and 6B are planar and cross-sectional views of a faceplate in a single 2D modulator having blaze profile including at least two planar surfaces extending parallel to each other and to a short axis of the array;

FIGS. 7A to 7D are planar and cross-sectional views of a faceplate in a single 2D modulator including elongated raised elements to form a phase grating;

FIG. 8 is a block diagram illustrating a system including DPM™ including an array of linearly ganged 2D modulators;

FIGS. 9A and 9B are schematic block diagrams of illumination optics to provide top-hat illumination of one or more pixels in a DPM™;

FIGS. 10A and 10B are schematic block diagrams of projection optics using Fourier lens based on Fraunhofer principles;

FIG. 11 is a schematic block diagram of an alternative projection optics using a basic Fresnel system; and

FIG. 12 is a schematic block diagram of another alternative projection optics using a micro lens array after 4f filter.

### DETAILED DESCRIPTION

A displacement phase modulator for high power laser phase modulation, and methods of operating the same for processing, manufacturing and communication applications are described herein with reference to the figures described above.

In the following description, for purposes of explanation, numerous specific details are set forth in order to provide a thorough understanding of the present invention. It will be evident, however, to one skilled in the art that the present invention can be practiced without these specific details. In other instances, well-known structures, and techniques are not shown in detail or are shown in block diagram form in order to avoid unnecessarily obscuring an understanding of this description.

Reference in the description to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment. The term to couple as used herein can include both to directly electrically connect two or more components or elements and to indirectly connect through one or more intervening components.

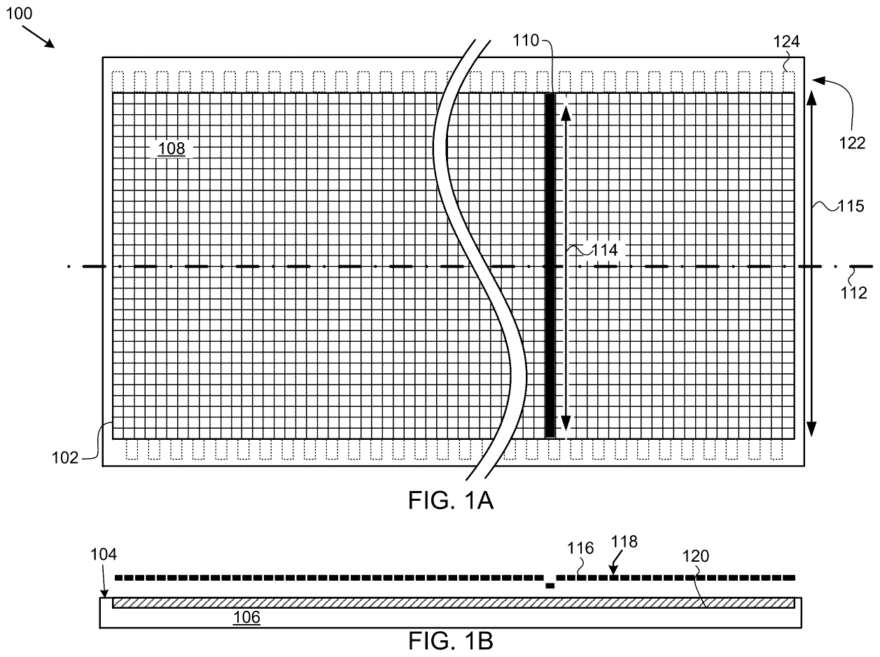

Electro-optic modulator are optical devices in which a signal-controlled optical element, such as a mirror or reflector, is used to modulate the phase, amplitude, or diffraction angle of a beam of light. One example of an electro-optical modulator for phase modulation is known as a displacement phase modulator (DPM™), available from Silicon Light Machines, Inc., of San Jose, California, will now be described with reference to FIGS. 1A and 1B. For purposes of clarity, many of the details of fabricating and operating electro-optical modulator, which are widely known and not relevant to the present invention, have been omitted from the following description. The drawings described are only schematic and are non-limiting. In the drawings, the size of some of the elements may be exaggerated and not drawn to scale for illustrative purposes. The dimensions and the relative dimensions may not correspond to actual reductions to practice of the invention.

FIG. 1A is a schematic block diagram of a planar top view of a displacement phase modulator (DPM™) including an array of Microelectromechanical systems (MEMS) based two-dimensional (2D) modulators. FIG. 1B is a simplified schematic block diagram in cross-sectional side view of the DPM™ 100. Referring to FIGS. 1A and 1B, the DPM™ 100 generally includes multiple 2D modulators 102 arranged in columns and rows on a surface 104 of a substrate 106 to form a linear array 108 having multiple pixels 110 along a longitudinal axis 112 of the array. Each pixel 110 includes multiple 2D modulators 102 in one or more adjoining columns with a long axis 114 transverse to the longitudinal axis 112 of the array 108. In some embodiments, such as that shown, the long axis 114 of each pixel 110 is coextensive with a short axis 115 of the array 108.

The 2D modulators 102 in each pixel 110 include a faceplate 116 having a light reflective surface 118 facing away from the surface 104 of the substrate 106 that is electrostatically displaceable relative to the surface of the substrate to modulate a coherent light incident thereon. The 2D modulators 102 in each pixel 110 are electrically coupled to receive a common input voltage signal or input signal to operate in unison to modulate a phase of light reflected therefrom in response to the input signal. By in unison it meant that the faceplate 116 of each 2D modulator 102 in the pixel 110 is displaced or deflected by substantially the same amount or distance relative to the surface 104 of the substrate (or a plane of an undeflected or static faceplate 116) at substantially the same time. Generally, the 2D modulators 102 in each pixel 110 can be arranged in a single column perpendicular to the longitudinal axis 112 of the array 108 and parallel to the surface of the substrate 106, or can be arranged in two or more adjoining columns perpendicular to the longitudinal axis of the array and parallel to the surface of the substrate.

The DPM 100 further includes a number of substrate electrodes 120 (shown in FIG. 1B) in or on the surface of the substrate 106, and a multi-channel, pixel drive circuit or driver 122 having a number of drive channels 124 each coupled to one or more substrate electrodes and to an actuator electrode (not shown in these figures) in one or more of the 2D modulators 102 in one of the pixels 110 in the array 108. The driver 122 can be integrally fabricated directly in or on the same substrate 106 with the array 108, as in the embodiment shown, to form a monolithic MEMS-based DPM™, using for example, complementary metal-oxide-semiconductor (CMOS) technology. In one embodiment, the driver 122 is formed laterally adjacent to the array 108 prior to or following forming the 2D modulators 102 of the array used standard MEMS fabrication techniques. In another embodiment, the driver 122 is formed prior to forming the 2D modulators 102 using a low temperature MEMS process so that in the finished DPM™ 100 the driver at least partially underlies the array 108.

Alternatively, the driver 122 can be fabricated on a second substrate or chip and electrically coupled thereto (not shown) using standard wire bonding, flip-chip or through silicon vias techniques.

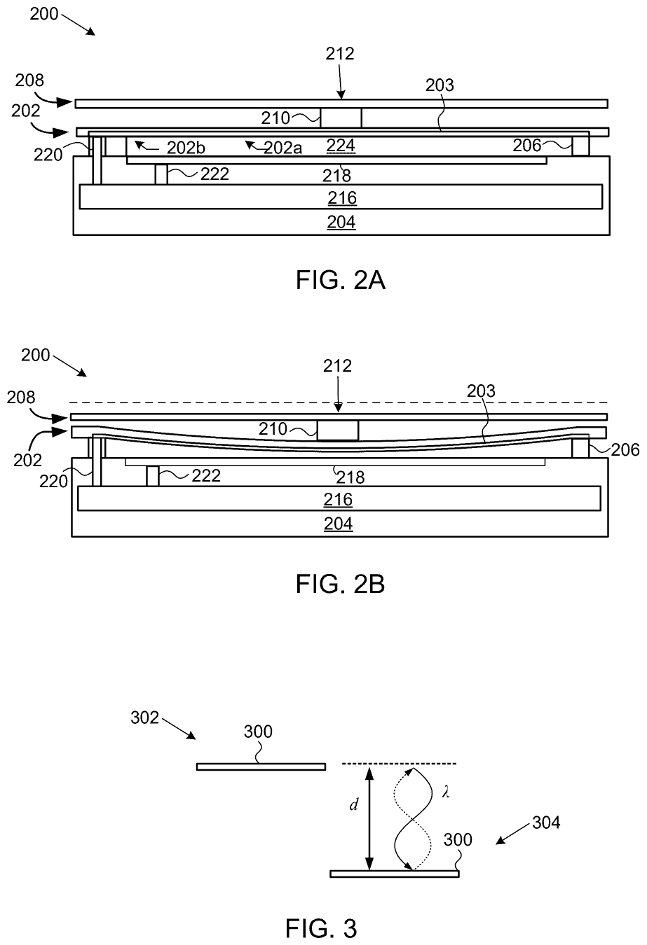

An embodiment of a 2D modulator 200 particularly suitable for use in an array of a MEMS-based DPM for phase modulation is shown in FIGS. 2A and 2B. FIGS. 2A and 2B are simplified schematic block diagrams illustrating a cross-sectional side view of the 2D modulator 200 in an undeflected or static state and in a deflected or active state, respectively. For purposes of clarity, many of the details of fabricating and operating MEMS-based 2D modulators, which are widely known and not relevant to the present invention, have been omitted from the following description. Such details are described in greater detail, for example, in commonly assigned U.S. Pat. No. 7,227,687, which is incorporated herein by reference in its entirety.

Referring to FIG. 2A, the 2D modulator 200 includes an actuator layer or actuator 202 suspended over a surface on a substrate 204 by posts 206 at corners of the 2D modulator. The actuator 202 includes a taut structural layer of tensile, silicon nitride (SiN) or tensile amorphous silicon germanium (SiGe) and a layer of conductive material to form an actuator electrode 203. In one embodiment, the actuator 202 includes tensile, amorphous SiGe, which has been implanted with impurities or dopants to form a conductive implanted SiGe layer that also functions as the actuator electrode. Suitable impurities and dopants include Boron (B), Aluminum (Al), Gallium (Ga), Indium (In), Silicon (Si), Gold (Au) Xenon (Xe) Nitrogen (N), and Argon (Ar), ion implanted to a concentration of about from about of about 1E13 atoms/cm³ to about of about 1E18 atoms/cm³.

The actuator 202 includes an electrostatically deflectable central piston or plate (CP 202a) and a number of flexures 202b through which the CP is flexibly or movably coupled to the posts 206. A faceplate 208 extending over substantially the entire 2D modulator is supported above and separated from the CP 202 a by a central post 210. In the embodiment shown, the faceplate 208 includes a single light reflective surface 212.

The 2D modulator 200 further includes a driver 216 integrally formed in or on the substrate 204 underlying at least some of the 2D modulators 200, the driver operable to generate a voltage between a substrate electrode 218 and the actuator electrode 203 to cause displacement of the CP 202a. The actuator electrode 203 is electrically coupled to one of a number drive channels in the driver 216 through a conductor 220 extending through one or more of the posts 206, and to the substrate electrode 218 through one or more vias 222 and metal layers (not shown in these figures).

FIG. 2B is a simplified schematic diagram illustrating a sectional side view of the 2D Modulator 200 of FIG. 2B in an active or driven state. The 2D Modulator 200 is operable so that electrostatic deflection of the CP 202a causes a coherent light reflected from the light reflective surface 212 of the faceplate 208 to be modulated in phase from that of the incident light and/or light reflected from static 2D modulators.

Materials of the light reflective surface 212 of the faceplate 208 are selected so that the DPM™ is operable to modulate light ranging from deep ultraviolet light (DUV) to near-infrared (NIR) at wavelengths from 150 nm to 2 μm. Suitable reflective materials can include aluminum (Al), gold (Au), silver (Ag) or any other suitably reflective metal. Alternatively, the reflective surfaces can include a multilayer dielectric or Bragg mirror including one or more alternating layers with different optical characteristics or properties, such as reflection, transmission and absorption depending on the wavelengths of the incident light being modulated.

FIG. 3 schematically illustrates displacement (d) of a faceplate 300 of a 2D modulator from a static state 302 to an active state 304 in relation to a wavelength (λ) of an incident light. Generally, the dimensions of the actuator 202, flexures 202b and a gap 224 between the actuator and surface of the substrate 204 are selected to enable the faceplate 208 to be deflected through a distance (d) equal to at least one half wavelength (λ) of the incident light to enable a 2π modulation. Preferably, the faceplate 208 is deflectable through one or more wavelengths of the incident light to enable both the phase and the amplitude of a reflected light to be modulated independently. More preferably, the faceplate 208 can be displaced by n*λ/2 wavelength, where λ is a particular wavelength of light incident on the DPM™ 100, and n is an integer equal to or greater than 1. Moving the faceplate 208 brings reflected light from the light reflective surfaces 212 of the 2D modulator 200 into constructive or destructive interference with light reflected from a 2D modulator in an adjoining pixel or light reflected from an adjoining 2D modulator in the same pixel, thereby modulating light incident on the DPM™.

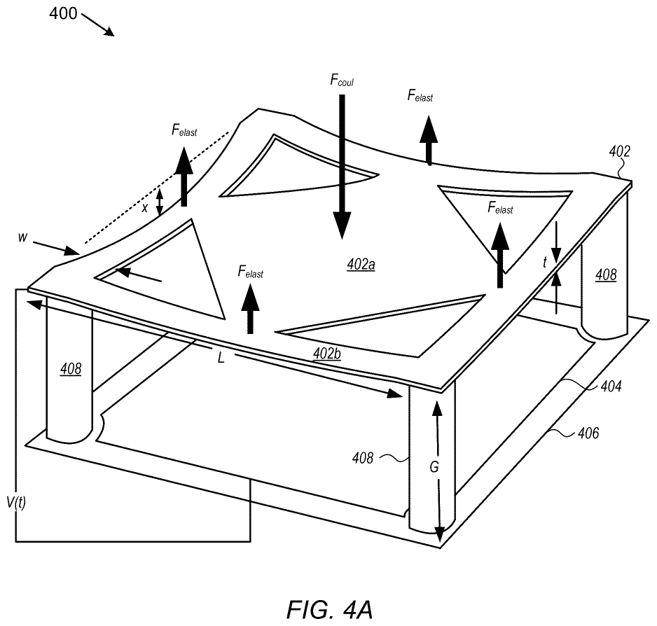

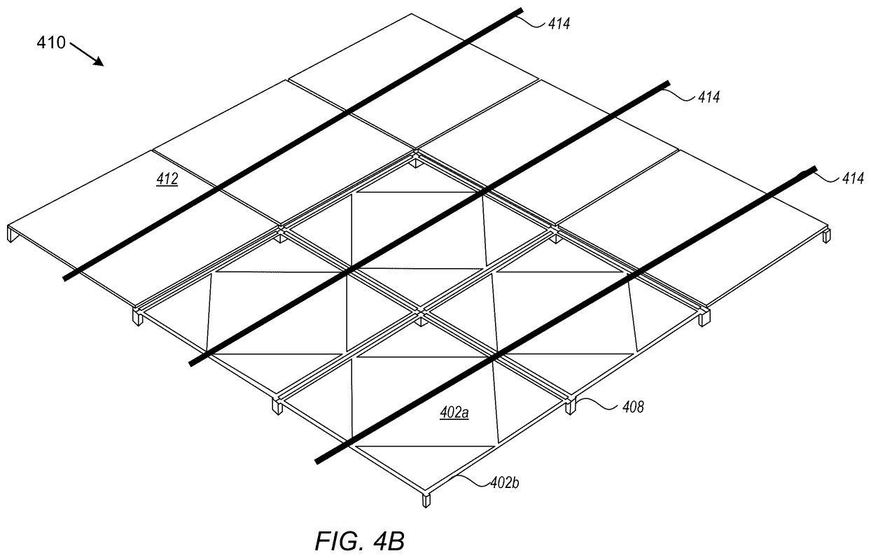

The forces on and operation of a 2D modulator and electrical ganging of multiple 2D modulators within a single pixel will now be described with reference to FIGS. 4A and 4B. FIG. 4A schematically illustrates an actuator layer or actuator for a single 2D modulator 400 with the faceplate removed and shows forces thereon resulting in deformation or movement. Referring to FIG. 4A the actuator 402 generally includes an electrostatically deflectable patterned central piston or plate (CP 402a) and a number of flexures 402b through which the CP is suspended over a substrate electrode 404 in a substrate 406 by a number of posts 408 at corners thereof. It is noted that the central piston or plate (CP 402a) do not have to be square, but can be circular having a sufficient mechanical coupling or anchoring to the flexures 402b to enable the faceplate to move in a substantially linear direction along an axis perpendicular to the faceplate, and has an actuator electrode with an area sufficient to generate the necessary electrostatic attraction forces.

Referring to FIG. 4A, a voltage potential (V(t)) applied between an actuator electrode in the actuator 402 and the substrate electrode 404 creates an electrostatic Coulomb attraction (F_{coul} in FIG. 4A) that deflects the actuator layer a distance x towards the substrate electrode. The electrostatic force is balanced by an elastic restoring force (Fₑₗₐₛₜ in FIG. 4A). The elastic restoring force, which is due to taut, tensile SiN or SiGe layer in the actuator 402, allows the actuator to revert back to a neutral state or position once the electrostatic force is removed.

FIG. 4B is schematic block diagram in perspective view of a portion of an array 410 of a DPM, such as shown in FIGS. 1A and 1B, in which some faceplates 412 have been removed to illustrate the central piston or plate (CP 402a) and flexures 402b of the underlying actuator 402, and solid lines 414 added to indicate direction of electrical ganging of the 2D modulators within a pixel. It is noted that solid lines 414 do not illustrate electrical connections between electrodes in the ganged 2D modulators 200 but only direction of electrical ganging. It is further noted that the electrical ganging can be accomplished either through electrically coupling or ganging the actuator electrodes of separate 2D modulators within the pixel, or by electrically coupling or ganging the substrate electrode 404 in the substrate 406 over which each 2D modulator is formed.

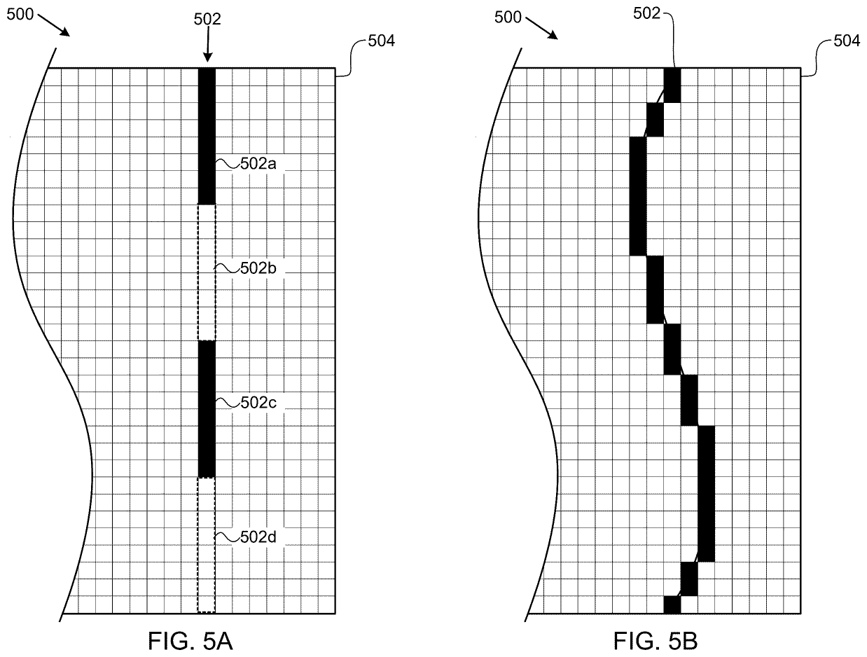

In the array shown FIG. 1 and described above the pixels are large, rectangular pixels in which all of the 2D modulators in each pixel are arranged in one or more adjoining columns perpendicular to the longitudinal axis of the array with the long axis of each pixel is coextensive with a short axis of the array and substantially equal to a width of the array. While such pixel configurations are uniquely suited to high power laser applications, other pixel configurations are possible. FIGS. 5A and 5B are schematic block diagrams of a planar top view of a portion of an array 500 in a DPM™ illustrating alternative pixel 502 configurations.

Referring to FIG. 5A, in a first embodiment two or more adjoining 2D modulators 504 arranged or configured in the array 500 to form smaller pixels 502a, 502b, 502c, 502d, arranged coaxially along a short axis of the array in one column of the array. As with the large, rectangular pixels 110 these smaller pixels are ganged or electrically coupled to operate in unison to modulate light reflected from each 2D modulator in the pixel in response to a common or shared input signal.

The 2D modulators can be ganged or electrically coupled to provide pixels having more exotic, non-linear shapes or configurations that offer optical or mechanical advantages in some applications. For example, referring to FIG. 5B, in another embodiment 2D modulators 504 in two or more adjacent columns on both sides of a longitudinal axis of the array can be ganged together to form a serpentine or S-shaped extending a full width of the array.

In FIGS. 2A and 2B, the faceplates of the 2D modulators are shown and described as having a single light reflective surface, however other configurations are possible in which the faceplate includes a number of raised surfaces or elements, each with a separate light reflective surface.

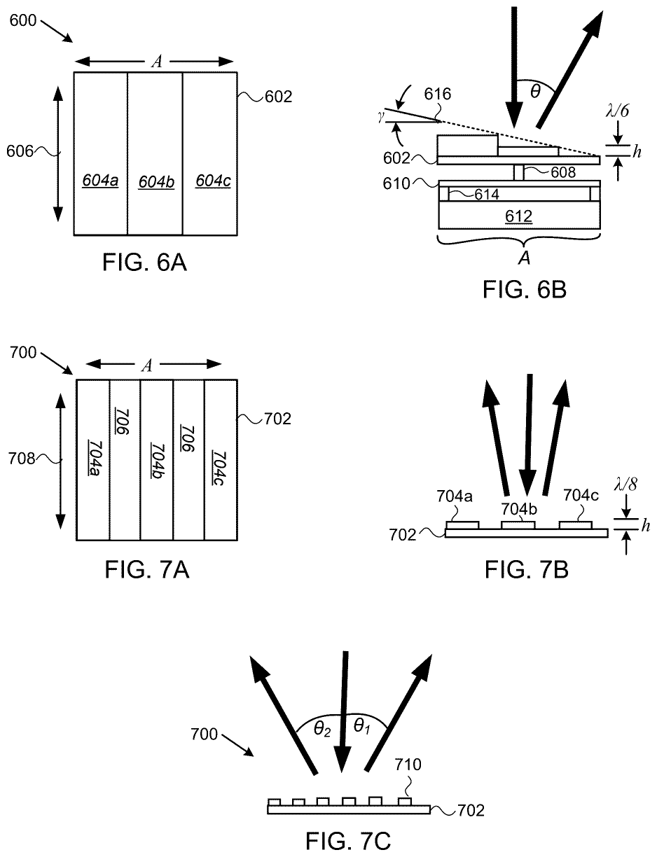

Referring to FIGS. 6A and 6B, in one embodiment the faceplate 602 of each of the 2D modulators 600 includes at least three planar surfaces 604a, 604b, 604c, each with a light reflective surface extending parallel to each other and to a long axis 606 of a pixel (not shown in this figure) including multiple 2D modulators to form a blazed grating or blaze profile. As in the embodiment shown in FIGS. 2A and 2B, the faceplate 602 is supported by a central post 608 above an actuator layer or actuator 610 suspended over a surface of a substrate 612 by posts 614 at corners of the 2D modulator 600.

A blazed grating is a special type of diffraction grating that is optimized for a particular wavelength or narrow range of wavelengths of incident light to achieve maximum grating efficiency in a given diffraction order. The blazed grating is operable to diffract an incident light into at least two diffraction orders including a first order. Generally, maximum optical power is concentrated in the selected diffraction order while the residual power in the other orders (particularly the zero^{th}) is minimized. Each of the planar surfaces 604a, 604b, 604c, have a substantially equal area or width perpendicular to the long axis 606, and a substantially equal step height (h) between adjacent surfaces dependent on the number of planar surfaces on the faceplate 602 and a wavelength of the incident light to be modulated. Generally, the step height (h) is given by the expression:

h=λ/2N

where h is the step height, λ is the wavelength of the incident light, and N is the number of planar surfaces on the faceplate 602.

Thus, for a faceplate having 3 planar surfaces as shown in FIGS. 6A and 6B the step height (h) between adjacent surfaces 604 a, 604 b, 604 c, would be equal to one sixth of the incident wavelength or λ/6.

A blaze angle 616 (γ) formed by the raised surfaces or elements on the faceplate 602 is also dependent on the number of planar surfaces 604a, 604b, 604c, and the wavelength of the incident light, and is generally given by the expression:

γ=arctan (λ/(NA))

where λ is the wavelength of the incident light, N is the number of planar surfaces on the faceplate 602, and A is the width of the faceplate 602 also known as a grating pitch.

Thus, for a faceplate having 3 planar surfaces as shown in FIGS. 6A and 6B the blaze angle 616 (γ) would be equal to γ=arcsin (λ/(3A)).

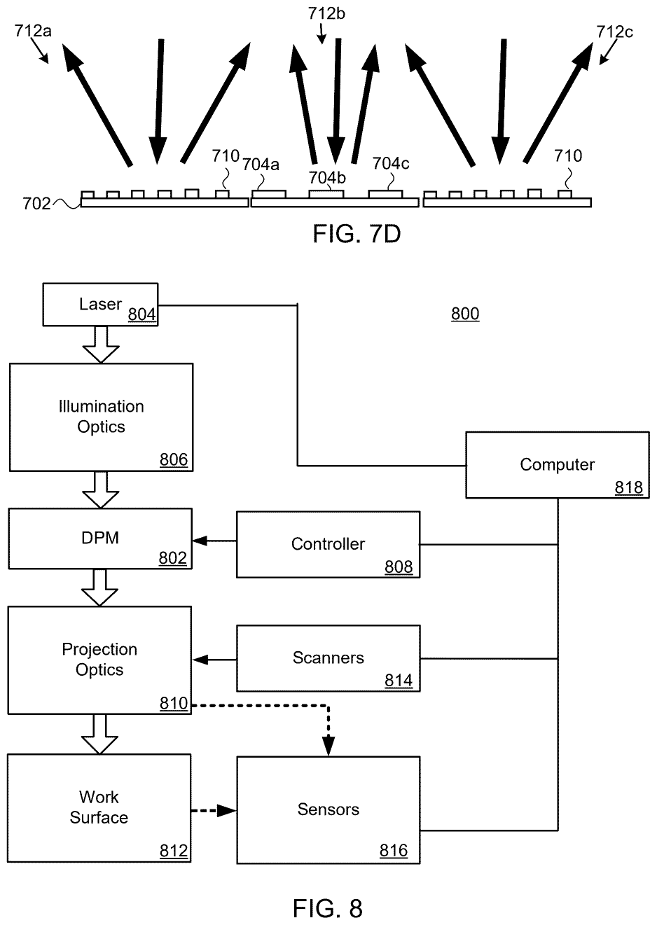

In another embodiment shown in FIGS. 7A to 7D the faceplate 702 in a single 2D modulator 700 includes multiple elongated elements 704a, 704b, 704c, each raised above a light reflective surface 706 on the faceplate and extending parallel to each other and to a long axis 708 of a pixel to form a phase grating. FIG. 7A illustrates a cross-sectional view of the faceplate 702, while FIG. 7B illustrates a planar top view of the faceplate. The phase grating can split the reflected, modulated light into at least two diffraction orders. Generally, as in the embodiment shown, the reflecting surfaces on each of the elongated elements 704a, 704b, 704c, are raised above the light reflective surface 706 on the faceplate 702 by at least one eighth of the wavelength of the incident light (λ/8) or more generally by n*λ/8, where n is an odd integer equal to or greater than one. However, it is noted that alternatively the height of one or more of the elongated elements 704a, 704b, 704c, on the faceplate 702 can be any fraction or multiple of the wavelength of the incident light to alter an amplitude or diffraction order of the modulated light.

FIG. 7C illustrates an embodiment in which the number of elongated elements 710 and a spacing or period or pitch there between can be altered to adjust an angle between diffraction orders. More particularly, FIG. 7C shows that by increasing the number of elongated elements 710 on the faceplate 702 and decreasing the spacing between the elements, the angles between diffraction orders (θ₁, θ₂) can be increased. Additionally, it is noted that the spacing between the number of elongated elements 710 can be can be any fraction or multiple of the wavelength of the incident light to alter the diffraction order of the modulated light.

FIG. 7D illustrates yet another embodiment in which the number of elongated elements 710 and 704a-c on faceplates 702 in adjacent pixels 712a, 712b, 712c, and the spacing there between can be different to create a desired wavefront response at a predetermined distance from the DPM. It will be further understood that the height of one or more of the elongated elements 710 and 704a-c, either on a single faceplate or on faceplates in adjacent pixels 712a, 712b, 712c, can be different to alter an amplitude or diffraction order of the modulated light.

FIG. 8 is a block diagram illustrating a system 800 including DPM™ 802 having an array of linearly ganged 2D modulators. Referring to FIG. 8, in addition to the DPM™ 802 the system 800 includes a coherent light source, such as a laser 804, illumination optics 806, a controller 808 to provide signals and power, including input voltage signals, to the DPM™, and projection optics 810. Generally, the laser 804 can be a high-power continuous wave (CW) or pulsed laser operating in wavelength ranges from UV to NIR and capable of generating optical power output greater than 1 kilowatt (kW). The illumination optics 806 can include anamorphic optics to substantially fully illuminate an array of the DPM™ 802. The projection optics 810 includes filtering, relay and magnification systems and elements to direct or project modulated light from the DPM™ onto a work sample or work surface 812.

In some embodiments, such as that shown, the system further includes a number of scanners 814 to scan the modulated light onto the work surface 812, a number of sensors 816, and a processor or computer 818 to control and synchronize operations of the laser 804, DPM™ 802, receive data from the sensors 816, and to calculate patterns and provide imaging data to the controller 808 for the DPM™. The sensors 816 can include, for example, cameras for in-line feedback or calibration of the system 800. The scanners 814 can include galvanometric mirrors to scan a swath of modulated light across the work surface 812.

It will be understood that a system such as that shown in FIG. 8 is useful in displays, optical information processing, data storage and printing applications, and is particularly suitable for use in systems requiring higher power densities, such as additive or subtractive processing applications, and in maskless photolithography or lithography systems for fabricating micro-electronic devices.

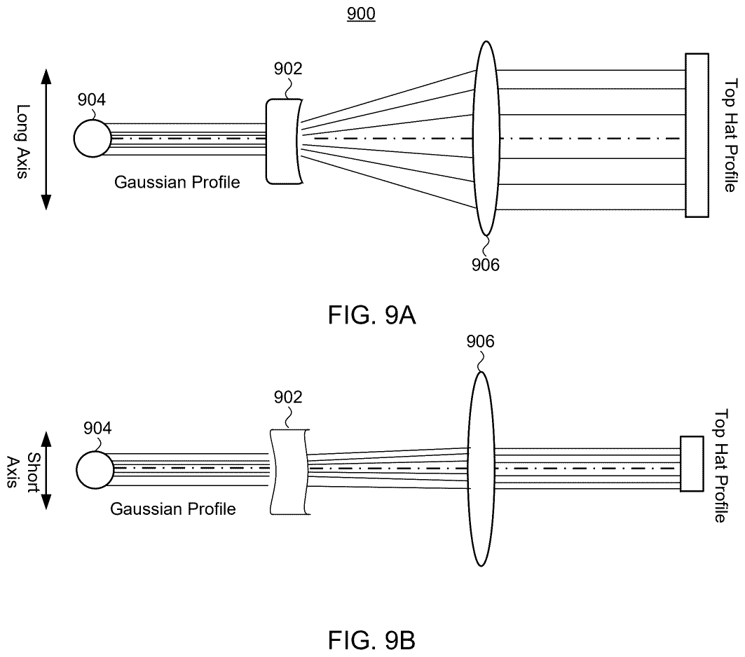

FIGS. 9A and 9B are schematic block diagrams illustrating an embodiment of anamorphic illumination optics 900. By anamorphic illumination optics it is meant an optical system having a number of optical elements including lenses, prisms and mirrors having different magnification along at least two non-parallel axes to substantially fully illuminate an array of the DPM™ 802. The illumination optics 900 are operable to create a top hat or elliptical Gaussian beam to substantially fully illuminate an array of the DPM™ 802. Referring to FIGS. 9A and 9B the illumination optics 900 generally includes include a cylindrical aspheric lens having a hyperbolic profile, sometimes called a Powell Lens 902 to spread light 904 from a laser along one axis, and a cylindrical, short axis focusing lens 906 to shape or focus the illumination into a rectangular beam or line of illumination extending substantially uniformly across the array of the DPM™ 802.

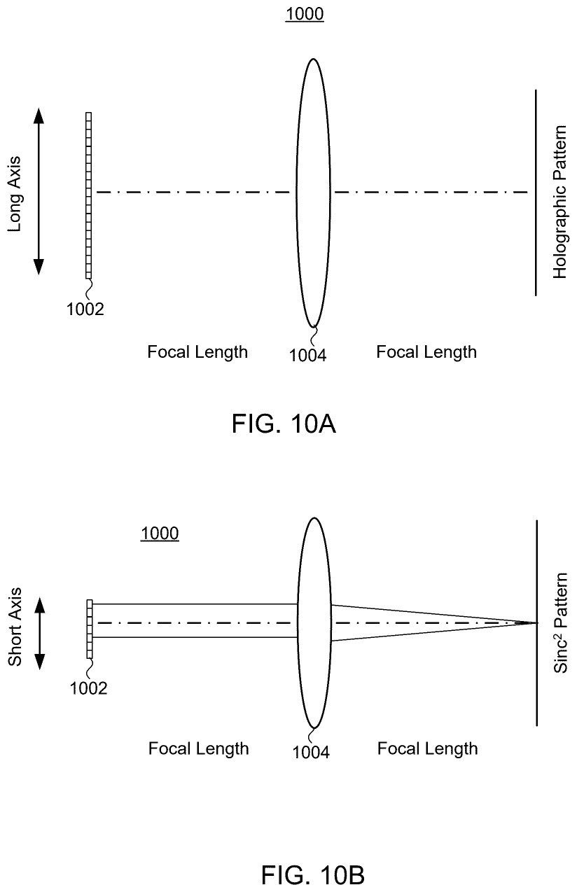

FIGS. 10A and 10B are schematic block diagrams of projection optics 1000 using Fourier lens based on Fraunhofer principles to create a Fraunhofer hologram. Referring to FIGS. 10A and 10B, light from a laser is illuminated onto a DPM™ 1002 using anamorphic optics as previously described above. The projection optics 1000 generally includes at least a single spherical Fourier lens 1004 located one focal distance or length from DPM™ 1002. The Fourier lens 1004 is configured or operable to create a hologram pattern as a real image one focal distance from the Fourier lens. Generally, the projection optics 1000 can further include subsequent optical elements, such as mirrors or lens, to relay and/or magnify the real image (hologram pattern) onto work surface by using standard optical techniques.

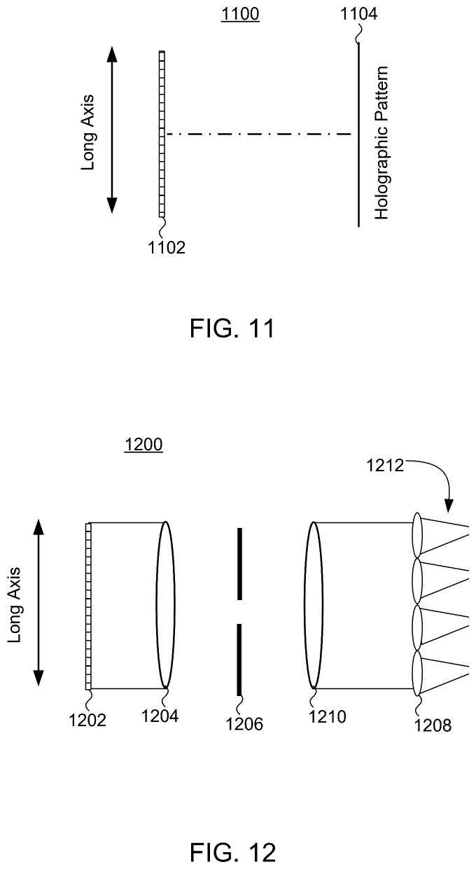

FIG. 11 is a schematic block diagram of alternative projection optics 1100 using a basic Fresnel system to create a hologram. Referring to FIG. 11 light from a laser is illuminated onto a DPM™ 1102 using anamorphic optics as previously described above. Modulated light reflected from the DPM™ 1102 projects a hologram pattern 1104 creating a real image at some distance from the DPM™ 1102 determined by Fresnel hologram. As with the previous embodiment, the projection optics 1100 generally further includes subsequent optical elements, such as mirrors or lens, to relay and/or magnify the real image onto a work surface by using standard optical techniques.

FIG. 12 is a schematic block diagram of projection optics 1200 using a micro lens array after 4f filter. Referring to FIG. 12, light from a laser is illuminated onto a DPM™ 1202 using anamorphic optics as previously described. The projection optics 1200 generally includes a spherical Fourier lens 1204 located one focal distance or focal length from DPM™ 1202, a 4f filter 1206, and a micro lens array 1208. The 4f filter 1206 is used to filter out DC diffraction orders creating a conjugate image at a second lens 1210. The micro lens array 1208 is used to create a real image having multiple beams 1212 that can be shaped or scanned view, separately onto a work surface.

Thus, embodiments of a DPM™ including an array of linearly ganged 2D modulators for high power laser phase modulation have been described. The DPM™ has been described with the aid of and reference to functional and schematic block diagrams illustrating implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It is to be understood that the Detailed Description section, and not the Summary and Abstract sections, is intended to be used to interpret the claims. The Summary and Abstract sections can set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

1. A displacement phase modulator comprising;
a plurality of two dimensional (2D) modulators arranged in columns and rows on a surface of a substrate to form an array including a plurality of pixels along a longitudinal axis, each pixel comprising a plurality of 2D modulators in one or more adjoining columns and having a long axis transverse to the longitudinal axis of the array; and
wherein the plurality of 2D modulators in each pixel are electrically coupled to receive a common input signal and to operate in unison to modulate a phase of light reflected therefrom in response to the input signal.

2. The displacement phase modulator of claim 1, wherein the substrate comprises a number of substrate electrodes in the surface thereof, and wherein each of the 2D modulators comprise:
an electrostatically displaceable actuator suspended above an upper surface on the substrate, the actuator comprising a tensile layer and including an actuator electrode; and
a faceplate supported by and separated from the surface of the substrate by the actuator, the faceplate having a light reflective surface facing away from the actuator,
wherein the actuator in each of the 2D modulators is operable to displace the faceplate in response to a voltage applied between the actuator electrode and one of the number of substrate electrodes.

3. The displacement phase modulator of claim 2, wherein the light reflective surface of each 2D modulator comprises a blaze profile including at least two planar surfaces extending parallel to each other and to a short axis of the array, the light reflective surface operable to diffract an incident light into at least a first order diffraction.

4. The displacement phase modulator of claim 2, wherein the light reflective surface of each 2D modulator comprises a number of elongated raised elements spaced apart and extending parallel to a short axis of the array to form a phase grating, and wherein the phase grating of each 2D modulator is operable to diffract an incident light into at least two diffraction orders including a first order.

5. The displacement phase modulator of claim 4, wherein the number of elongated raised elements on faceplates in adjacent pixels, and the spacing there between is different to create a predetermined wavefront response at a predetermined distance from the displacement phase modulator.

6. The displacement phase modulator of claim 1, wherein the plurality of 2D modulators in each pixel are arranged in a single column perpendicular to the longitudinal axis of the array and parallel to the surface of the substrate.

7. The displacement phase modulator of claim 1, wherein the plurality of 2D modulators in each pixel are arranged in two or more adjoining columns perpendicular to the longitudinal axis of the array and parallel to the surface of the substrate.

8. The displacement phase modulator of claim 1, wherein the plurality of 2D modulators in each pixel comprise all of the 2D modulators in one or more columns of the array, and wherein the long axis of each pixel is coextensive with a short axis of the array.

9. The displacement phase modulator of claim 1, wherein the plurality of 2D modulators in each pixel are in one column of the array, and wherein the plurality of pixels includes two or more pixels arranged coaxially along a short axis of the array in one column of the array.

10. A system comprising:
a laser;
a displacement phase modulator including a plurality of two dimensional (2D) modulators arranged in columns and rows on a surface of a substrate to form an array including a plurality of pixels along a longitudinal axis, each pixel comprising a plurality of 2D modulators in one or more adjoining columns and having a long axis transverse to the longitudinal axis of the array, and
illumination optics operable to illuminate the displacement phase modulator with light from the laser; and
projection optics operable to focus modulated light from the displacement phase modulator onto a work surface,
wherein each of the 2D modulators comprise an electrostatically displaceable actuator suspended above an upper surface on the substrate, the actuator comprising a tensile layer and including an actuator electrode, and faceplate supported by and separated from the surface of the substrate by the actuator, the faceplate having a light reflective surface facing away from the actuator,
wherein the actuator in each of the 2D modulators is operable to displace the faceplate in response to a input voltage signal applied between the actuator electrode and a substrate electrode in the substrate, and
wherein the plurality of 2D modulators in each pixel are electrically coupled to receive a common input voltage signal and to operate in unison to modulate a phase of light reflected therefrom in response to the input voltage signal.

11. The system of claim 10, wherein the plurality of 2D modulators in each pixel are arranged in one or more adjoining columns perpendicular to the longitudinal axis of the array and parallel to the surface of the substrate, and wherein the long axis of each pixel is coextensive with a short axis of the array.

12. The system of claim 10, further comprising a scanner to control the projection optics to scan modulated light across the work surface, sensors to sense parameters of modulated light at the work surface, a controller to provide input signals to the displacement phase modulator, and a processor (computer) to receive data from the sensors and to control the laser, the displacement phase modulator, and the scanner to synchronize the laser, the displacement phase modulator, and the scanner or sensor.

13. The system of claim 10, wherein the illumination optics comprises phase flattening optics operable to illuminate the array with a constant intensity and phase.

14. The system of claim 10, wherein the illumination optics comprises anamorphic optics operable to illuminate the array with a top-hat or elliptical Gaussian beam profile.

15. The system of claim 10, wherein the projection optics comprises a Fresnel system operable to generate a Fresnel hologram distal from the displacement phase modulator that is then relayed onto the work surface.

16. The system of claim 10, wherein the projection optics comprises a Fraunhofer system including a Fourier lens one focal distance from the displacement phase modulator, and is operable to generate a Fraunhofer hologram distal one focal distance from the Fourier lens that is then relayed onto the work surface.

17. The system of claim 10, wherein the projection optics comprises a four focal length (4f) optical system including a first Fourier lens one focal distance from the displacement phase modulator, a filter in a Fourier plane one focal distance from the first Fourier lens, a second Fourier lens one focal distance from the Fourier plane and micro lens array after the second Fourier lens is used to filter out DC diffraction orders, and wherein the projection optics are operable to form a real image of multiple beams from the micro lens array that can be separately shaped or scanned onto the work surface.

18. A two dimensional (2D) modulator for modulating a phase of light incident thereon, the 2D modulator comprising:
an electrostatically displaceable actuator suspended above a surface of a substrate, the actuator comprising a tensile layer and including an actuator electrode; and
a faceplate supported by and separated from the surface of the substrate by the actuator, the faceplate having elongated reflective elements arranged parallel to each other and operable to diffract incident light into at least a first diffraction order,
wherein the actuator in is operable to displace the faceplate in response to an input voltage signal applied between the actuator electrode and a substrate electrode in the substrate to modulate a phase of the incident light.

19. The 2D modulator of claim 18, wherein the elongated reflective elements comprise at least two planar surfaces extending parallel to each other and to a short axis of the array, and the faceplate comprises a blaze profile.

20. The 2D modulator of claim 18, wherein the elongated reflective elements form a phase grating, and wherein the phase grating is operable to diffract incident light into at least two diffraction orders including the first diffraction order.
